(19) United States
(12) Patent Application Publication
(10) Pub. No.: US 2005/0050325 A1
(43) Pub. Date: Mar. 3, 2005

(54) ID check device, ID generation device, and authentication system

(76) Inventor: Kenichi Ohkubo, Katano-shi (JP)

Correspondence Address: FISH & RICHARDSON PC, 225 FRANKLIN ST, BOSTON, MA, 02110, US

(21) Appl. No.: 10/924,578

(22) Filed: Aug. 24, 2004

(30) Foreign Application Priority Data
Aug. 26, 2003 (JP) 2003-301525

(51) Int. Cl. H04L 9/00

(52) U.S. Cl. 713/168

(57) ABSTRACT

An authentication system for determining whether an appropriate external device is attached to a main device. The main device includes an authentication device and an ID check device, which is incorporated in an exclusive authentication chip. The authentication device is arranged separately from the exclusive authentication chip. In response to an authentication request signal from the authentication device, the ID check device generates a first identification signal for the main device and compares it with a second identification signal of the external device. The ID check device then provides the authentication device with an authentication result signal that is in accordance with the comparison result. The authentication device only determines whether the external device is appropriate based on the authentication result signal.

### CROSS-REFERENCE TO RELATED APPLICATIONS

This application is based upon and claims the benefit of priority from prior Japanese Patent Application No. 2003-301525, filed on Aug. 26, 2003, which is herein incorporated in its entirety by reference.

### BACKGROUND OF THE INVENTION

The present invention relates to an ID check device, an ID generation circuit, and an authentication system, and more particularly, to an authentication system used when recognizing whether or not an external device connected to a main device is the proper device.

A portable electronic device, such as a portable phone, normally has a battery pack, which is detachably attached to the main body of the portable device. When the battery deteriorates, the battery pack is replaced by a new one so that the portable device may be continuously used.

Progress made to reduce the manufacturing cost of the battery pack may decrease the quality of the battery pack. The portable device may not function properly when using such a battery pack. Further, such a battery pack may produce unpredictable heat and cause an abnormality in the electronic device.

Japanese Laid-Open Patent Publication No. 2003-162986 describes a battery pack authentication system using an identification signal to recognize battery packs having the necessary quality.

FIG. 1 is a block diagram of a conventional authentication system 40 that identifies a battery pack 42 (external device), which is detachably attached to a portable device 41 (main device). The portable device 41 includes a microcomputer 43. Data is communicated between the microcomputer 43 and an exclusive authentication LSI 44, which is incorporated in the battery pack 42 so that the microcomputer 43 can identify the battery pack 42.

When the battery pack 42 is attached to the portable device 41, the microcomputer 43 activates an authentication processing program 51 to generate a code (code sequence) for acquiring an identification signal (ID signal) The ID signal identifies whether or not the battery pack 42 is an appropriate one. Based on the code, an encryption processing program 52 of the microcomputer 43 performs a predetermined operation (encryption) to generate a first identification signal for identifying the portable device 41.

The code is provided to the exclusive authentication LSI 44 via a communication circuit 53 of the microcomputer 43. An encryption processing circuit 55 of the exclusive authentication LSI 44 performs a predetermined operation (encryption processing) based on the code to generate a second identification signal for identifying the battery pack 42. The second identification signal is transferred to the authentication processing program 51 via a communication circuit 54 of the exclusive authentication LSI 44.

The authentication processing program 51 compares the first identification signal and the second identification signal to determine whether the battery pack 42 is appropriate for the portable device 41.

In the conventional authentication system 40, the microcomputer 43 performs software processing to generate the identification signal (first identification signal) for the portable device 41 that is used for authentication processing. Thus, the encryption algorithm of the encryption processing program 52, which generates the identification signal, must be disclosed to the software developer (normally, a large number of programmers). As a result, there is a risk of encryption information leakage. Further, in the authentication system 40, data is directly transferred between the microcomputer 43 and the exclusive authentication LSI 44, and the authentication process is performed by the microcomputer 43. Thus, there is another risk of leakage of the authentication method or communication method (communication protocol) used for data communication.

### SUMMARY OF THE INVENTION

One aspect of the present invention is an authentication system for use with a first device and a second device when attached to one another for authenticating the first device as appropriate for the second device. The system includes an authentication device, arranged in the second device, for generating an authentication request signal. An ID check device is arranged in the second device separately from the authentication device. The ID check device generates, in response to the authentication request signal, a first identification signal used to identify the second device, receives from the first device a second identification signal used to identify the first device, compares the first identification signal and the second identification signal, generates an authentication result signal in accordance with the comparison result, and provides the authentication result signal to the authentication device.

A further aspect of the present invention is an ID check device used in an authentication system for use with a first device and a second device attached to one another for authenticating the first device as appropriate for the second device. The second device includes an authentication device for generating an authentication request signal. The first device generates an identification signal used to identify the first device. The ID check device includes an authentication processing circuit for performing an authenticating process on the first device in response to the authentication request signal. An encryption processing circuit generates another identification signal, which is encrypted and used to identify the second device. A communication circuit performs communication with the first device in accordance with a predetermined communication protocol. The communication circuit transmits the ID acquisition code to the first device to acquire the identification signal from the first device. The authentication processing circuit compares the identification signals to generate an authentication result signal in accordance with the comparison result and provides the authentication result signal to the authentication device.

Another aspect of the present invention is an ID generation device incorporated in a first device for attachment to a second device having an ID acquisition code. The ID generation device includes a semiconductor device. A communication circuit performs communication with the first device in accordance with a predetermined communication protocol to receive the ID acquisition code from the second device and transmit an identification code to the second device when the first device is attached to the second device. An encryption processing circuit receives the ID acquisition code from the communication circuit, and performs a predetermined encryption process on the ID acquisition code to generate the identification signal. The communication circuit and the encryption processing circuit are both integrated on the semiconductor device.

A further aspect of the present invention is an authentication system for use with a first device and a second device when attached to one another for authenticating the first device as appropriate for the second device. The system includes an authentication device, arranged in the second device, for generating an authentication request signal. An ID check device is arranged in the second device separately from the authentication device for generating, in response to the authentication request signal, a first identification signal used to identify the second device and an ID acquisition code. An ID generation device is incorporated in the first device for performing communication with the ID check device in accordance with a predetermined communication protocol. The ID generation device receives the ID acquisition code from the ID check device, performs a predetermined encryption process on the ID acquisition code to generate a second identification signal, and transmits the second identification signal to the ID check device. The ID check device compares the first identification signal and the second identification signal to generate an authentication result signal in accordance with the comparison result and provides the authentication result signal to the authentication device. The authentication device determines whether the first device is appropriate based on the authentication result signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing an authentication system of the prior art;

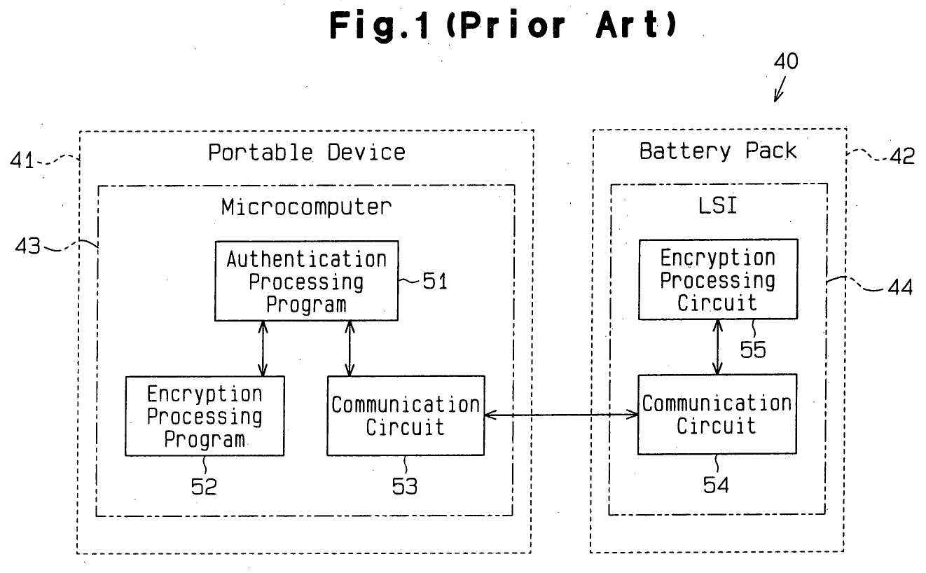

FIG. 2 is a schematic diagram showing an authentication system according to a preferred embodiment of the present invention; and

FIG. 3 is a block diagram showing the configuration of the authentication system of FIG. 2 in detail.

### DETAILED DESCRIPTION OF THE PREFERRED EMBODIMENTS

An authentication system 10 according to a preferred embodiment of the present invention will now be discussed. The authentication system 10 identifies a battery pack that is attached to a portable device, such as a portable phone.

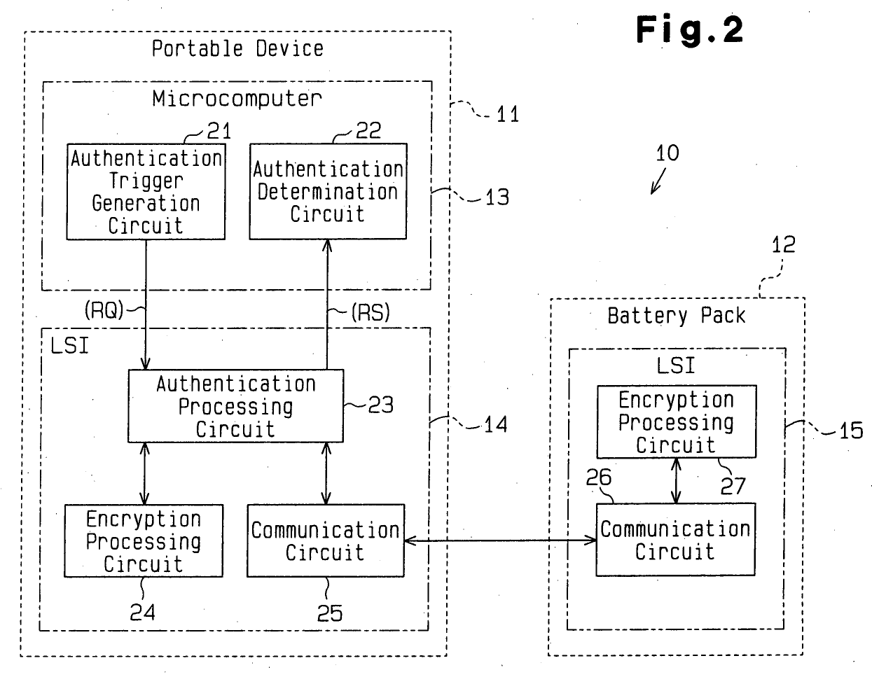

Referring to FIG. 2, a battery pack 12 (external device) is detachably attached to a portable device 11 (main device of a portable phone).

The portable device 11 includes a microcomputer 13, which functions as an authentication device for identifying whether the battery pack 12 attached to the portable device 11 is an appropriate one, and an exclusive LSI (first LSI) 14, which functions as an ID check device. The battery pack 12 includes a battery (not shown) and an exclusive LSI (second LSI) 15, which functions as an ID generation circuit. The portable device 11 and the battery pack 12 are electrically connected to each other by a power supplying terminal (not shown).

The authentication system 10 will now be discussed. The microcomputer 13 of the portable device 11 includes an authentication trigger generation circuit 21 and an authentication determination circuit 22. When the battery pack 12 is attached to the portable device 11, the authentication trigger generation circuit 21 generates an authentication request signal RQ for requesting an authentication processing circuit 23 of the first LSI 14 to perform an identification process (authentication process) on the battery pack 12. The authentication determination circuit 22 receives an authentication result signal RS from the authentication processing circuit 23 and determines whether the battery pack 12 is an appropriate one based on the authentication result signal RS.

The first LSI 14 is a semiconductor device that includes the authentication processing circuit 23, an encryption processing circuit 24, and a communication circuit 25. In response to the authentication request signal RQ output from the authentication trigger generation circuit 21, the authentication processing circuit 23 performs the authentication process on the battery pack 12.

More specifically, when receiving the authentication request signal RQ, the authentication processing circuit 23 acquires a first identification signal, which is required to identify and authenticate the portable device 11, from the encryption processing circuit 24. The encryption processing circuit 24 receives data used to generate the identification signal from the authentication processing circuit 23 and performs an encryption process on the received data in accordance with a predetermined encryption algorithm to generate the first identification signal.

The authentication processing circuit 23 performs data communication with a second LSI 15 incorporated in the battery pack 12 in accordance with a predetermined communication protocol and acquires a second identification signal, which is required to identify the battery pack 12, from the second LSI 15 via the communication circuit 25. Then, the authentication processing circuit 23 identifies the battery pack 12 based on the acquired first and second identification signals and provides the authentication determination circuit 22 with an authentication result signal RS indicating the result.

The second LSI 15 is a semiconductor device including a communication circuit 26, which performs communication processing with the first LSI 14, and an encryption processing circuit 27, which generates the second identification signal. The encryption processing circuit 27 receives data used to generate the identification signal from the authentication processing circuit 23 via the communication circuit 26 and performs encryption processing on the received data in accordance with a predetermined encryption algorithm to generate the second identification signal.

In the preferred embodiment, the encryption processing circuit 24 of the first LSI 14 and the encryption processing circuit 27 of the second LSI 15 have the same configuration and perform encryption processing in accordance with the same encryption algorithm. That is, the encryption processing circuits 24 and 27 generate the same identification signal for the same data provided from the authentication processing circuit 23.

In the authentication system 10, the authentication processing circuit 23 compares the first identification signal, which is generated by the encryption processing circuit 24 of the first LSI 14, and the second identification signal, which is generated by the encryption processing circuit 27 of the second LSI 15, in response to the authentication request signal RQ from the authentication trigger generation circuit 21. The authentication determination circuit 22 is provided with the authentication result signal RS in accordance with the comparison result. Then, the authentication determination circuit 22 determines whether the battery pack 12 is an appropriate one based on the authentication result signal RS. In the preferred embodiment, the battery pack 12 is determined as being appropriate for the portable device 11 when the authentication processing circuit 23 outputs an authentication result signal RS indicating that the first identification signal and the second identification signal are the same.

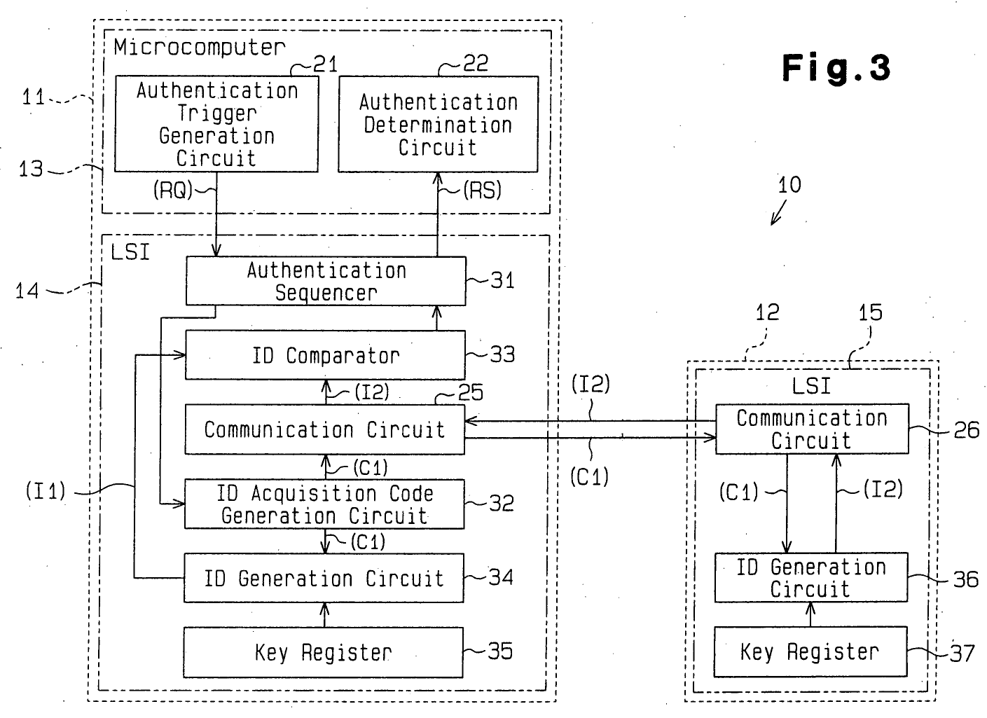

The detailed configuration and processing flow of the authentication system 10 will now be discussed with reference to FIG. 3. Parts that are similar to those shown in FIG. 2 are denoted with the same reference numeral.

The authentication processing circuit 23 (FIG. 2) of the first LSI 14 is divided in accordance with function into an authentication sequencer 31, an ID acquisition code generation circuit (hereafter referred to as the “code generation circuit”) 32, and an ID comparator 33. The encryption processing circuit 24 (FIG. 2) of the second LSI 15 is divided in accordance with function into an ID generation circuit 34 and a key register 35. The encryption processing circuit 24 (FIG. 3) of the first LSI 14 is divided in accordance with function into an ID generation circuit 36 and a key register 37. The other parts are the same as FIG. 2.

In the authentication system 10, when the battery pack 12 is attached to the portable device 11, the authentication trigger generation circuit 21 generates and transmits the authentication request signal RQ to the authentication sequencer 31. In response to the authentication request signal RQ, the authentication sequencer 31 initiates the authentication process. That is, when receiving the authentication request signal RQ, the authentication sequencer 31 first activates the code generation circuit 32 in order to acquire an identification signal (first identification signal) for the portable device 11 and an identification signal for the battery pack 12 (second identification signal), which are required to perform the authentication process. The code generation circuit 32 generates an ID acquisition code C1, which is required to generate the identification signals. In the preferred embodiment, the ID acquisition code C1 includes random data (code sequence) having a variable data length.

Then, the authentication sequencer 31 transmits the ID acquisition code C1 generated by the code generation circuit 32 to the ID generation circuit 34, which generates a first identification signal I1. More specifically, the ID generation circuit 34 uses key information, which is registered in the key register 35, to perform a predetermined operation (encryption process) on the ID acquisition code C1 and generate the first identification signal I1. The ID generation circuit 34 then provides the first identification signal I1 to the ID comparator 33.

The authentication sequencer 31 also transmits the ID acquisition code C1 generated by the code generation circuit 32 to the ID generation circuit 36 of the second LSI 15 via the communication circuits 25 and 26. The ID generation circuit 36 generates a second identification signal 12. More specifically, the ID generation circuit 36 uses key information, which is registered in the key register 37, to perform a predetermined operation (encryption process) on the ID acquisition code C1 and generate the second identification signal 12. The ID generation circuit 36 then provides the second identification signal 12 to the ID comparator 33 via the communication circuits 26 and 25.

The authentication sequencer 31 then uses the ID comparator 33 to compare the first identification signal I1 generated by the ID generation circuit 34 and the second identification signal 12 generated by the second LSI 15 (ID generation circuit 36). More specifically, the ID comparator 33 checks whether the first identification signal I1 and the second identification signal I2 match. Then, the authentication sequencer 31 transmits the authentication result signal RS, which is in accordance with the comparison result (determination result), to the authentication determination circuit 22.

In the microcomputer 13, based on the authentication result signal RS received from the first LSI 14, the authentication determination circuit 22 determines only whether the battery pack 12 is appropriate. In other words, when receiving the authentication result signal RS that indicates that the first identification signal I1 and the second identification signal I2 match, the authentication determination circuit 22 determines that the battery pack 12 is appropriate for the portable device 11.

The authentication system 10 of the preferred embodiment has the advantages described below.

(1) The portable device 11 is provided with the exclusive authentication LSI (first LSI) 14, which includes the authentication processing circuit 23 for performing the authentication process on the battery pack, the encryption processing circuit 24 for generating the first identification signal 11 of the portable device 11 that is required to perform the authentication process, and the communication circuit 25 for performing data communication with the battery pack 12. In the authentication system 10 that uses the exclusive authentication LSI (first LSI) 14, the algorithm used in the encryption processing to generate the first identification signal 11 is incorporated in the LSI 14. Thus, the confidentiality of the encryption algorithm is increased. This prevents leakage of encryption information and realizes a system having high confidentiality.

(2) The encryption processing circuit 24 is incorporated in the exclusive authentication LSI (first LSI) 14 as hardware and not as software. Thus, the algorithm for encryption processing incorporated in the LSI 14 is undisclosed. Accordingly, confidentiality is maintained at a high level even with a relatively simple algorithm.

(3) A relatively simple encryption algorithm may be used without being disclosed. This reduces the burden of developing software for the encryption process. Accordingly, the cost for producing a system having a high level of security is low.

(4) In the authentication system 10, the first LSI 14 incorporates authentication processing circuit 23, which performs the authentication process on the battery pack 12 and the communication circuit 25, which performs the communication process with the second LSI 15 of the battery pack 12. Further, data communication related with the authentication process is performed between the first LSI 14 and the second LSI 15. In addition to the encryption method the authentication method and communication method (communication protocol) are also incorporated in the LSI 14. Thus, the confidentiality of the system is extremely high. This prevents leakage of unique authentication sequences and communication protocols and enables the configuration of a system having a higher level of confidentiality.

(5) In the preferred embodiment, the microcomputer 13 performs only a process in which the authentication request signal RQ, which is used to authenticate the battery pack 12, is generated and transmitted to the first LSI 14 and a process in which the authentication result signal RS is received from the first LSI 14 and used to determine whether the battery pack 12 is appropriate. This significantly reduces the processing load on the microcomputer 13 in comparison with the conventional system.

(6) By changing the configuration of the first LSI 14, the authentication system 10 is applicable for changes in the encryption, authentication, and communication methods in different types of devices.

(7) The ID generation circuits 34 and 36, which perform a predetermined operation (encryption process) on the random code sequence (ID acquisition code C1) generated by the code generation circuit 32, are respectively arranged in the first LSI 14 and the second LSI 15. Accordingly, random data is communicated between the microcomputer 13 and the first LSI 14 and between the first LSI 14 and the second LSI 15. This avoids making the authentication procedure for the battery pack 12 easily recognizable even if the communications are monitored.

(8) In the preferred embodiment, the ID generation circuits 34 and 36, which perform the same operation to generate an identification signal, are respectively arranged in the portable device 11 and the battery pack 12. Thus, confidentiality is ensured and the identification process is properly performed.

It should be apparent to those skilled in the art that the present invention may be embodied in many other specific forms without departing from the spirit or scope of the invention. Particularly, it should be understood that the present invention may be embodied in the following forms.

The encryption processing circuit 24 of the first LSI 14 in the portable device 11 and the encryption processing circuit 27 of the second LSI 15 in the battery pack 12 have the same configuration. However, the encryption processing circuits 24 and 27 may have different configurations (different encryption processing algorithms). In this case, the ID comparator 33 compares identification signals that are in accordance with the difference in the encryption processes.

The ID generation circuit 34 of the first LSI 14 and the ID generation circuit 36 of the second LSI 15 may be provided with different ID acquisition codes. In this case, the ID comparator 33 compares the identification signals that are in accordance with the difference in the ID acquisition codes.

The application of the present invention is not limited to a system for identifying a battery pack 12 attached to a portable device 11. For example, the present invention may be applied to any system that recognizes an external device detachably attached to a main device, such as a system that identifies an ink cartridge attached to a printer.

The authentication trigger generation circuit 21, which generates the authentication request signal RQ, and the authentication determination circuit 22, which performs determinations based on the authentication result signal RS, do not have to be incorporated in the microcomputer 13 and may be arranged in exclusive authentication hardware.

The present examples and embodiments are to be considered as illustrative and not restrictive, and the invention is not to be limited to the details given herein, but may be modified within the scope and equivalence of the appended claims.

1. An authentication system for use with a first device and a second device when attached to one another for authenticating the first device as appropriate for the second device, the system comprising:
an authentication device, arranged in the second device, for generating an authentication request signal; and
an ID check device, arranged in the second device separately from the authentication device, the ID check device generating, in response to the authentication request signal, a first identification signal used to identify the second device, receiving from the first device a second identification signal used to identify the first device, comparing the first identification signal and the second identification signal, generating an authentication result signal in accordance with the comparison result, and providing the authentication result signal to the authentication device.

2. The authentication system according to claim 1, wherein the ID check device includes:
an authentication processing circuit for authenticating the first device, the authentication processing circuit generating an ID acquisition code in response to the authentication request signal;
a first encryption processing circuit for receiving the ID acquisition code and performing a predetermined encryption process on the ID acquisition code to generate the first identification signal; and
a first communication circuit for performing communication with the first device in accordance with a predetermined communication protocol;
the first communication circuit transmitting the ID acquisition code to the first device to acquire the second identification signal from the first device; and
the authentication processing circuit comparing the first identification signal and the second identification signal to generate the authentication result signal in accordance with the comparison result and providing the authentication result signal to the authentication device.

3. The authentication system according to claim 1, wherein the authentication device includes:
an authentication trigger generation circuit for generating the authentication request signal and providing the authentication request signal to the ID check device; and
an authentication determination circuit for receiving the authentication result signal from the ID check device and determining whether the first device is appropriate based on the authentication result signal.

4. The authentication system according to claim 1, wherein the first device is an external device and the second device is a main device.

5. An ID check device used in an authentication system for use with a first device and a second device attached to one another for authenticating the first device as appropriate for the second device, the second device including an authentication device for generating an authentication request signal, and the first device generating an identification signal used to identify the first device, the ID check device comprising:
an authentication processing circuit for performing an authenticating process on the first device in response to the authentication request signal;
an encryption processing circuit for generating another identification signal, which is encrypted and used to identify the second device; and
a communication circuit for performing communication with the first device in accordance with a predetermined communication protocol;
the communication circuit transmitting the ID acquisition code to the first device to acquire said identification signal from the first device; and
the authentication processing circuit comparing the identification signals to generate an authentication result signal in accordance with the comparison result and providing the authentication result signal to the authentication device.

6. The ID check device according to claim 5, wherein the first device is an external device and the second device is a main device.

7. An ID generation device incorporated in a first device for attachment to a second device having an ID acquisition code, the ID generation device comprising:
a semiconductor device;
a communication circuit for performing communication with the first device in accordance with a predetermined communication protocol to receive the ID acquisition code from the second device and transmit an identification code to the second device when the first device is attached to the second device; and
an encryption processing circuit for receiving the ID acquisition code from the communication circuit, and performing a predetermined encryption process on the ID acquisition code to generate the identification signal, the communication circuit and the encryption processing circuit both being integrated on the semiconductor device.

8. The ID generation device according to claim 7, wherein the first device is an external device and the second device is a main device.

9. An authentication system for use with a first device and a second device when attached to one another for authenticating the first device as appropriate for the second device, the system comprising:
an authentication device, arranged in the second device, for generating an authentication request signal;
an ID check device, arranged in the second device separately from the authentication device, for generating, in response to the authentication request signal, a first identification signal used to identify the second device and an ID acquisition code; and
an ID generation device, incorporated in the first device, for performing communication with the ID check device in accordance with a predetermined communication protocol, the ID generation device receiving the ID acquisition code from the ID check device, performing a predetermined encryption process on the ID acquisition code to generate a second identification signal, and transmitting the second identification signal to the ID check device,
the ID check device comparing the first identification signal and the second identification signal to generate an authentication result signal in accordance with the comparison result and providing the authentication result signal to the authentication device, and
the authentication device determining whether the first device is appropriate based on the authentication result signal.

10. The authentication system according to claim 9, wherein the authentication device generates the authentication request signal when the first device is attached to the second device and provides the authentication request signal to the ID check device.

11. The authentication system according to claim 9, wherein the authentication device is incorporated in a first semiconductor device, and the ID check device is incorporated in a second semiconductor device that differs from the first semiconductor device.

12. The authentication system according to claim 11, wherein the ID generation device is integrated on a single semiconductor device.

13. The authentication system according to claim 9, wherein the first device is an external device and the second device is a main device.
